(19) United States
(12) Patent Application Publication
(10) Pub. No.: US 2016/0292648 A1
(43) Pub. Date: Oct. 6, 2016

(54) Web-Based System and Method for Facilitating In-Person Group Activities Having Democratic Administration by Group Members

(71) Applicant: GymLink, Inc., Bristol, TN (US)

(72) Inventor: John Marshall Cowan, Bristol, TN (US)

(21) Appl. No.: 14/674,180

(22) Filed: Mar. 31, 2015

(51) Int. Cl. G06Q 10/10; G06Q 50/00

(52) U.S. Cl. CPC G06Q 10/1095; G06Q 50/01

(57) ABSTRACT

A computer implemented method for facilitating in-person activities includes the steps of electronically receiving information from a user for a proposed in-person activity, electronically generating a tentative activity posting for the proposed in-person activity within a group feed, electronically receiving positive interest level for the tentative activity posting from users of the group feed, electronically generating an activity page for the proposed in-person activity when a predetermined number of the positive interest level is received from the users, and electronically deleting the tentative activity posting for the proposed in-person activity at a predetermined time if the predetermined number of the positive interest level has not been received from the users. The tentative activity posting for the proposed in-person activity does not permit users to electronically enroll in the proposed in-person activity. The activity page for the proposed in-person activity permits users to electronically enroll in the proposed in-person activity.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to systems and methods for facilitating in-person group activities, events or meetings and, more particularly, to such systems and methods which are web-based and at least partially have democratic administration by group members.

### BACKGROUND OF THE INVENTION

In social networking, people are often interested in forming groups of people having a common interest or interests. These online groups can be used connect the online users in real life via in-person group activities.

Most current online sites that facilitate groups follow a pretty simple hierarchy. The administrator(s) has absolute control in choosing the group name, choosing the group's profile picture(s), restricting who can join the group, granting permissions, deleting and/or adding content to the group page(s), scheduling group activities or events, etc. Often, if the group is large, moderators are granted restricted permissions to manage content and users of the group. Users typically have the least control over their own group, interacting with it, and one another, only on the terms of the administrator. This group system, wherein one person (or a very small group of people) has absolute control, can be referred to as an autocratic type group (although sometimes they are technically more oligarchic).

U.S. Pat. No. 8,359,206, the disclosure of which is expressly incorporated herein in its entirety by reference, was issued to Meetup, Inc. and discloses an example of an autocratic type group system. While the Meetup, Inc. system gives administrators the option to have members vote on locations, agendas, times, and/or other variables when scheduling an activity, it is simply a poll of the users. The Administrator controls the voting options and ultimately makes the decision after voting is done. It is entirely up the administrators to decide whether to take into account the vote and if so, to what degree. In continuing the government systems analogies, this is a benevolent dictatorship.

Additionally, for many administrators in the Meetup, Inc. system, their groups serve as a business. The Meetup, Inc. system offers the ability for administrators to charge users dues and/or fees for participating in activities or events. While this inspires hosts to put together some great experiences, it gives the service a transactional feel and may reduce the number of users that decide to participate in the activities or events.

These current systems present a number of problems, the most concerning of which is an activity or event bottleneck. One administrator (or a small group of administrators) often can't create the number of activities that a large number of users need and/or want. Additionally, with one person making the decisions as to the types of activities or events added, the activities or events will likely be less varied. If you enjoy an activity but don't share the tastes of the Administrator you're out of luck. Furthermore, there is the possibility of administrators bullying users, acting in the disinterest of the group, and/or generally abusing their power.

Businesses or organizations that may benefit from sponsoring online groups may elect not to be a sponsor because of concerns about these current systems. First, administration of online groups can require a substantially large amount of their staff's time, and can mandate hiring additional employees. Second, individual members gaining too much influence within the community as group administrators. Businesses and organizations certainly do not want to provide a platform that could enable someone to lead an exodus of customers or members from their business or organization.

Accordingly, there is a need for improved systems and methods for electronically facilitating in-person activities that are reliable, provide a positive user experience, and/or reduce administrative costs for the sponsor.

### SUMMARY OF THE INVENTION

Disclosed are systems, methods, and software for facilitating in-person activities which address one or more issues of the related art as described above. Disclosed is a computer implemented method for facilitating in-person activities. The disclosed method comprises the steps of, in combination, electronically receiving information from a user for a proposed in-person activity, electronically generating a tentative activity posting for the proposed in-person activity within a group feed, electronically receiving positive interest level for the tentative activity posting from users of the group feed, electronically generating an activity page for the proposed in-person activity when a predetermined number of the positive interest level is received from the users, and electronically deleting the tentative activity posting for the proposed in-person activity at a predetermined time if the predetermined number of the positive interest level has not been received from the users. The tentative activity posting for the proposed in-person activity does not permit users to electronically enroll in the proposed in-person activity. The activity page for the proposed in-person activity permits users to electronically enroll in the proposed in-person activity.

Also disclosed is a system for facilitating in-person activities comprising, in combination, at least one central computer having memory, a processor in communication with the memory, and a network interface in communication with the processor for communicating with mobile electronic devices. The memory comprises computer-executable instructions executable by the processor to perform the steps of electronically receiving information from a user for a proposed in-person activity, electronically generating a tentative activity posting for the proposed in-person activity within a group feed, electronically receiving positive interest level for the tentative activity posting from users of the group feed, electronically generating an activity page for the proposed in-person activity when a predetermined number of the positive interest level is received from the users, and electronically deleting the tentative activity posting for the proposed in-person activity at a predetermined time if the predetermined number of the positive interest level has not been received from the users. The tentative activity posting for the proposed in-person activity does not permit users to electronically enroll in the proposed in-person activity. The activity page for the proposed in-person activity permits users to electronically enroll in the proposed in-person activity.

Also disclosed is one or more computer-readable media storing an application for facilitating in-person activities comprising computer-executable instructions that responsive to execution cause operations to be performed comprising, in combination, electronically receiving information from a user for a proposed in-person activity, electronically generating a tentative activity posting for the proposed in-person activity within a group feed, electronically receiving positive interest level for the tentative activity posting from users of the group feed, electronically generating an activity page for the proposed in-person activity when a predetermined number of the positive interest level is received from the users; and electronically deleting the tentative activity posting for the proposed in-person activity at a predetermined time if the predetermined number of the positive interest level has not been received from the users. The tentative activity posting for the proposed in-person activity does not permit users to electronically enroll in the proposed in-person activity. The activity page for the proposed in-person activity permits users to electronically enroll in the proposed in-person activity.

From the foregoing disclosure and the following more detailed description of various preferred embodiments it will be apparent to those skilled in the art that the present invention provides a significant advance in the technology and art of systems and methods for electronically facilitating in-person activities. Particularly significant in this regard is the potential the invention affords for providing easy to use systems and methods for electronically facilitating in-person activities that require relatively little to no administration by the sponsoring organization and provide a positive user experience. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is schematic view of a web-based system according to the present invention.

FIG. 1A is schematic view of an exemplary user mobile device of the system of FIG. 1.

FIG. 1B is schematic view of an exemplary sponsor computer of the system of FIG. 1.

FIG. 1C is schematic view of an exemplary service provider server of the system of FIG. 1.

FIG. 2 is front view of an exemplary user mobile device having an application displaying an exemplary user homepage or dashboard of the system of FIG. 1.

FIG. 3 is a front view of the exemplary user mobile device of FIG. 2 wherein the application is displaying an exemplary recommended groups page.

FIG. 4 is a front view of the exemplary user mobile device of FIGS. 2 and 3 wherein the application is displaying an exemplary individual group page.

FIG. 5 is a front view of the exemplary user mobile device of FIGS. 2 to 4 wherein the application is displaying an exemplary schedule page with an aggregated schedule of upcoming events.

FIG. 6 is a front view of the exemplary user mobile device of FIGS. 2 to 5 wherein the application is displaying an exemplary individual upcoming activity page.

FIG. 7 is another front view of the exemplary user mobile device of FIG. 6 wherein the exemplary individual upcoming activity page is scrolled down.

FIG. 8 is a block diagram illustrating an exemplary method for starting a new group of the system of FIG. 1.

FIG. 9 is front view of an exemplary user mobile device having an application displaying an exemplary new group selection page of the method of FIG. 8.

FIG. 10 is a block diagram illustrating an exemplary method of proposing an in-person activity for a group of the system of FIG. 1.

FIG. 11 is front view of an exemplary user mobile device having an application displaying an exemplary home page with a select activity link of the method of FIG. 10.

FIG. 12 is a front view of the exemplary user mobile device of FIG. 11 wherein the application is displaying an exemplary suggested activity input page.

FIG. 13 is a front view of the exemplary user mobile device of FIGS. 11 and 12 wherein the application is displaying an exemplary tentative activity input page.

FIG. 14 is a front view of the exemplary user mobile device of FIGS. 11 to 13 wherein the application is displaying an exemplary schedule page with an aggregated schedule of upcoming events.

FIG. 15 is a front view of the exemplary user mobile device of FIGS. 11 to 14 wherein the application is displaying an exemplary individual upcoming activity page.

FIG. 16 is a block diagram illustrating an exemplary method for selecting photographs for a group photograph collage of the system of FIG. 1.

It should be understood that the appended drawings are not necessarily to scale, presenting a somewhat simplified representation of various preferred features illustrative of the basic principles of the invention. The specific design features of the systems as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the systems illustrated in the drawings.

### DETAILED DESCRIPTION OF CERTAIN DISCLOSED EMBODIMENTS

It will be apparent to those skilled in the art, that is, to those who have knowledge or experience in this area of technology, that many uses and design variations are possible for the systems, methods, and software for electronically facilitating in-person activities or events as disclosed herein. The following detailed discussion of various alternative and preferred embodiments will illustrate the general principles of the invention with regard to a particular embodiment. Other embodiments suitable for other applications will be apparent to those skilled in the art given the benefit of this disclosure.

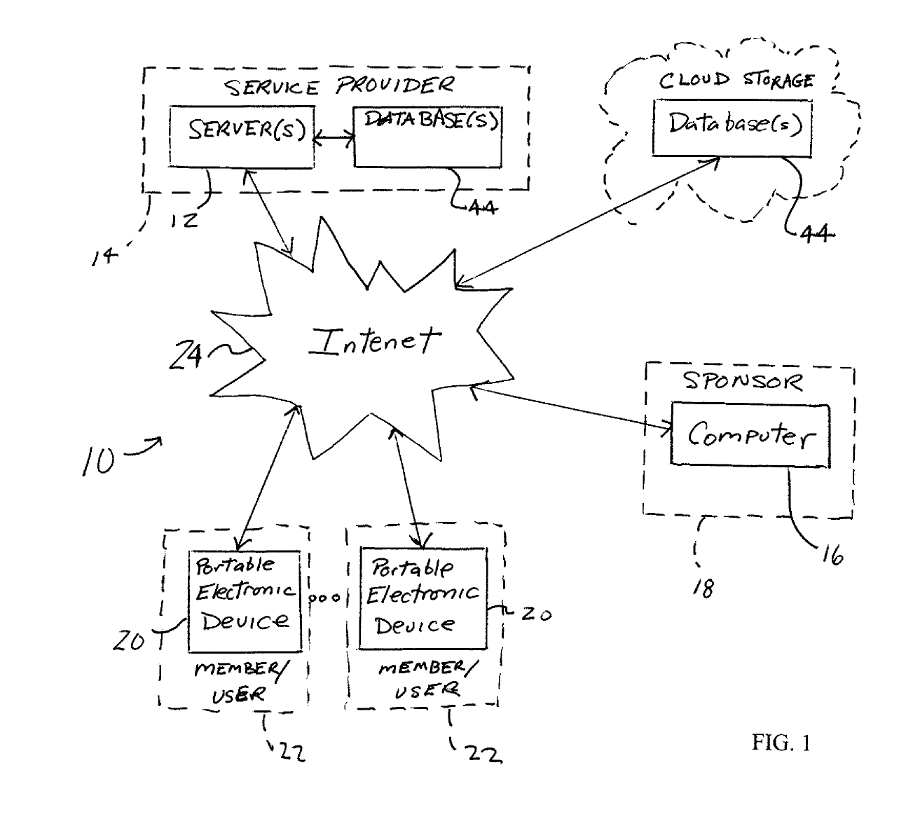

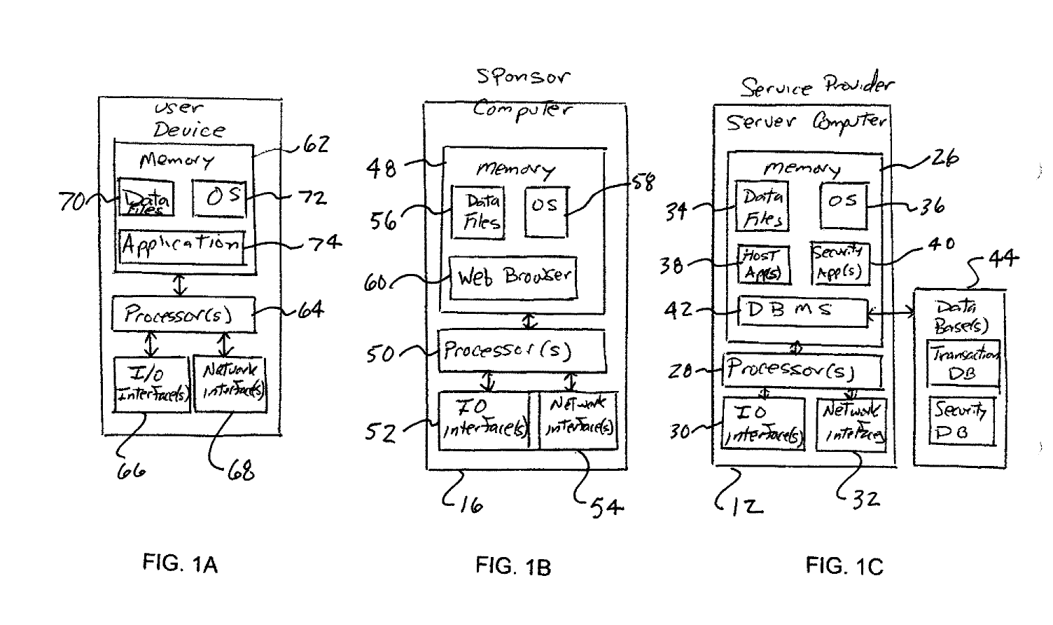

Referring now to the drawings, FIG. 1 illustrates a system 10 for electronically facilitating in-person group activities or events according to the present invention. The group activity or event can be any kind of activity or event where there is sufficient interest among group members or users. The illustrated system 10 includes at least one service provider server or computer 12 located at a service provider 14, at least one sponsor computer 16 located at an system or app sponsor 18, and a plurality of mobile devices or portable electronic devices 20 of group members or users 22. The term “server” is used in the specification and claims to mean a computer configured to manage, store, send and process data 24-hours a day. The term “computer” is used in the specification and claims to mean any electronic device that can suitably communicate via a computer network including, but not limited to, desktop computers, laptop computers, notebook computers, tablet computers, smart phones, personal digital assistants (PDAs), digital cameras, mp3 players, video game systems, messaging systems, video players, smart televisions, and the like. The terms “portable electronic device” and “mobile device” are used in the specification and claims to mean a handheld electronic device that utilizes rechargeable batteries as a power source and that that can suitably communicate with event system server via the computer network including, but not limited to, smart phones, personal digital assistants (PDAs), mp3 or other music players, video game players, messaging systems, tablet computers, notebook computers, and the like

The illustrated service provider server 12, the illustrated sponsor computer 16, and the illustrated user mobile devices 20 are in electronic communication with one another via a communication system 24. The illustrated communication system 24 is a computer network such as the Internet but any other suitable communication system can alternatively be utilized such as, for example, an intranet, any other type network of computers, and the like.

The illustrated service provider server or computer 12 includes memory 26, at least one processor or central processing units (CPU) 28 in communication with the memory 26, one or more input/output (IO) interfaces 30 in communication with the processor 28, and at least one network interface 32 in communication with the processor 28, all of which is configured to carry out the functions and steps described herein (best shown in FIG. 1C). The illustrated memory 26 stores data files 34, an operating system (OS) 36, host applications 38 for communications with web browsers and mobile applications, security applications 40 for limiting access to authorized users, and a database management system 42 for interfacing with databases 44 having stored information. It is noted that any other suitable information and/or software can be stored in the processor 28 and/or the memory 26. The illustrated databases 44 are separate from the service provider server or computer 12 but it is noted that the databases 44 can alternatively be integrated with the service provider server or computer 12. The illustrated databases 44 are located at the service provider 14 and/or a cloud location 46 but it is noted that the databases 44 can alternatively be located at any other suitable location and/or be of any other suitable type. The illustrated databases 44 include a transaction database and a security database but any other suitable types of databases can alternatively or additionally be utilized. The at least one processor 28 can be of any suitable type. The at least one 10 interface 30 can be of any suitable type such as a keyboard, a mouse, a track ball, a touch pad, a camera, a speaker, a monitor, a printer, a modem, a disk drive and the like. The network interface 32 can be of any suitable type such as, for example, a network interface card, software simulating a network card, and the like. The illustrated processor 28 and memory 26 are programmed with computer software for facilitating in-person activities or events including providing a web portal for interfacing with the sponsor computer 16 and the user mobile devices 22 as described in more detail hereinafter.

The illustrated service provider server or computer 12 is located at the service provider 14 and can be accessed by both sponsors 18 and group members or users 22 via the communication system 24. It is noted that while the illustrated software is provided by the service provider 14 to the sponsor 18 as software as a service (SaaS), the software can alternatively be provided in other suitable manners such as provided by a sponsor server or computer 16, an activity or event location server or computer, and the like. It is also noted that while the illustrated system 10 shows a single sponsor, it should be appreciated that the service provider typically provides such SaaS services to a plurality of different sponsors in the form of businesses, organizations, and the like. It is further noted that the service provider server 12 is not necessarily physically located at physical facilities of the service provider 14. In many instances the system 10 is cloud based.

The illustrated sponsor computer 16 includes memory 48, at least one processor or central processing units (CPU) 50 in communication with the memory 48, one or more input/output (10) interfaces 52 in communication with the processor 50, and at least one network interface 54 in communication with the processor 50, all of which is configured to carry out the functions and steps described herein (best shown in FIG. 1B). The illustrated memory 48 stores data files 56, an operating system (OS) 58, and a web browser 60. It is noted that any other suitable information and/or software can be stored in the processor 50 and/or memory 48. The at least one processor 50 can be of any suitable type. The at least one 10 interface 52 can be of any suitable type such as a keyboard, a mouse, a track ball, a touch pad, a camera, a speaker, a monitor, a printer, a modem, a disk drive and the like. The network interface 54 can be of any suitable type such as, for example, a network interface card, software simulating a network card, and the like. The illustrated processor 50 and memory 48 are programmed with the web browser 60 for communicating with the web portal of the service provider server 12 as described in more detail hereinafter.

The illustrated sponsor computer 16 is located at the sponsor 18 such as, for example, a place of business of the sponsor 18 but it is noted that he sponsor computer 16 can be located at any other suitable location such as the activity or event location, the service provider location, and the like. It is noted that the sponsor computer 16 can be a desktop computer or a mobile computer. It is further noted that that while the illustrated system 10 shows a single sponsor computer 16, it should be appreciated that there is typically a plurality sponsor computers 16 at one or more locations.

The illustrated user mobile devices 20 each include memory 62, at least one processor or central processing units (CPU) 64 in communication with the memory 62, one or more input/output (IO) interfaces 66 in communication with the processor 64, and at least one network interface 66 in communication with the processor 62, all of which is configured to carry out the functions and steps described herein (best shown in FIG. 1A). The illustrated memory 62 stores data files 70, an operating system (OS) 72, and a mobile application 74. It is noted that any other suitable information and/or software can be stored in the processor 64 and/or memory 66. The at least one processor 64 can be of any suitable type. The at least one 10 interface 66 can be of any suitable type such as a keyboard, a mouse, a track ball, a touch pad, a camera, a speaker, a touch screen, and the like. The network interface 68 can be of any suitable type such as, for example, a network interface card, software simulating a network card, and the like. The illustrated processor 64 and memory 62 are programmed with the mobile app or application 74 for communicating with the web portal of the service provider server 12 as described in more detail hereinafter. The terms “mobile app” and “mobile application” are used in the specification and claims to mean a type of application software designed to run on a mobile device to provide users with similar services to those accessed on personal computers.

The illustrated user mobile devices 20 are typically physically located with the users 22, that is physically located at the activity or event during the activity or event, but it is appreciated that other than during the event (and time immediately surrounding the event), the user mobile devices 20 will likely be in other locations because the user mobile devices 20 are mobile. It is noted that that while the illustrated system 10 shows a two users 22 having mobile devices 20, it should be appreciated that there is typically more than two users 22 having mobile devices 20.

The illustrated system software or web platform resides at the service provider server 12 and is accessible to the sponsor 18 via a web portal or dashboard on the sponsor computer 16 and to a user 22 via a mobile application dashboard or home page on the user's mobile device 20.

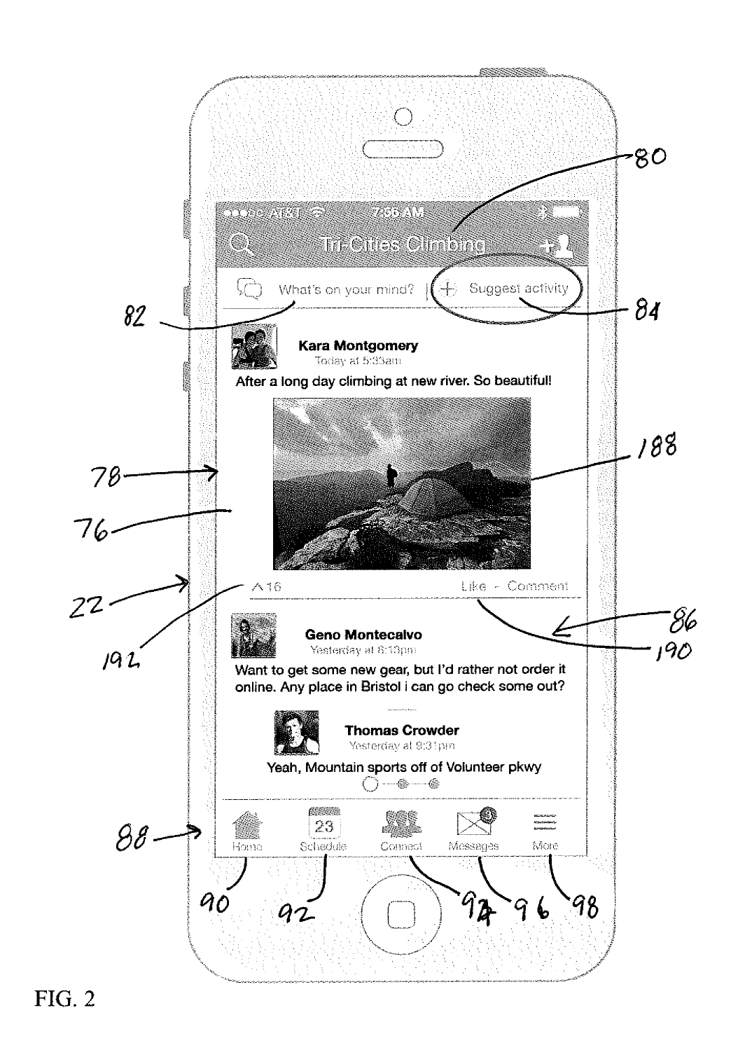

FIG. 2 illustrates an exemplary user's mobile device 22 displaying the application dashboard or home page 76 on a touch screen 78 with a group feed displayed. The illustrated home page 76 displays the name of the group (“Tri-Cities Climbing”) 80 at the top of the page 76. Also displayed are links or inputs (“What's on your mind?” and “Suggest activity”) 82, 84 on the touch screen 78 that when selected or touched by the user 22 will take the user 22 to a user communication input page and a proposed in-person activity input page respectively. Below the links 82, 84, the illustrated user group home page 76 displays posted communications or posts from group users 2 from most recent to oldest. Below the posted communications 86, the illustrated user group home page 76 is a row of links or inputs (“Home”, “Schedule”, “Connect”, Messages, and “More”) 88 on the touch screen that when selected or touched by the user 22 will take the user to an associated page. The first link 90 takes the user to the home page 78 for the mobile application 74. The second link 92 takes the user to a schedule page of the mobile application 74 showing an aggregated schedule of upcoming activities or events. The third link 94 takes the user 22 to a connect page of the mobile application 74. The fourth link 96 takes the user to a message page of the mobile application 74. The fifth link 100 takes the user 22 to links to additional pages of the mobile application 74. In the illustrated embodiment, the row of links 88 is displayed at the bottom of the touch screen 76 at all times while the mobile application 74 is running. Alternatively, the row of links 88 can change based on the page displayed and/or can be located at the bottom of the pages. It is noted that the row of links 88 can alternatively have any other suitable quantity and/or type of links. It is also noted that the home page 76 can alternatively have any other suitable form.

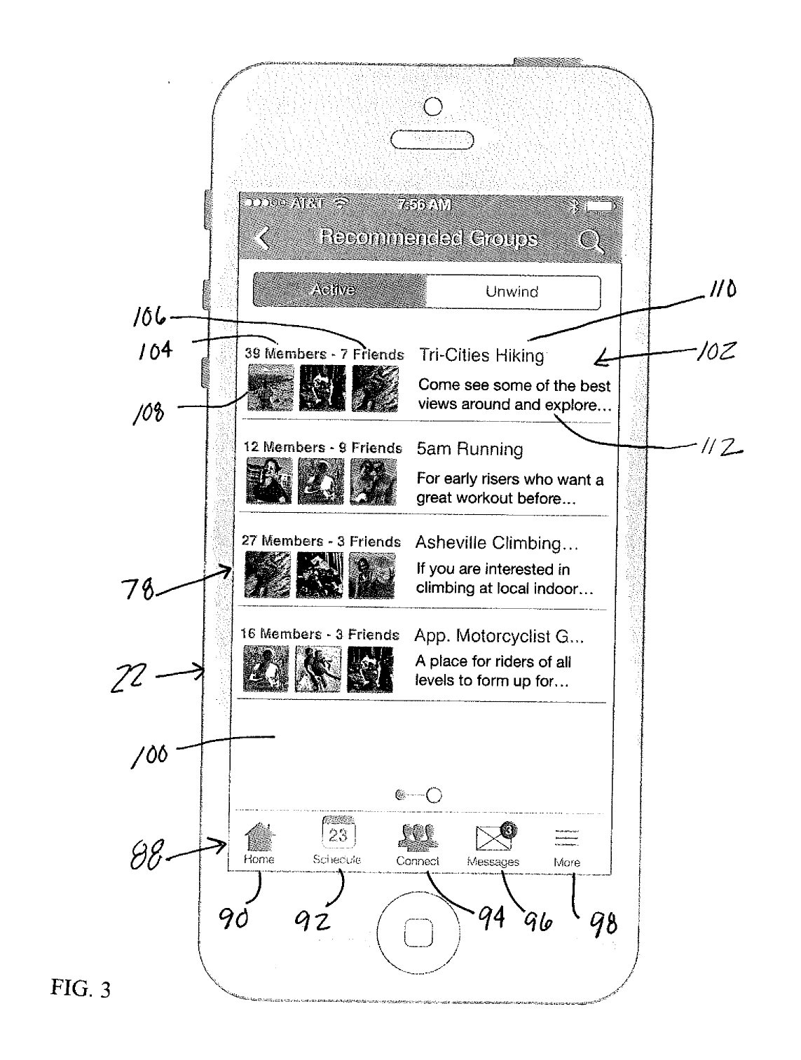

FIG. 3 illustrates an exemplary recommended groups page 100 displaying a list of groups that the user 22 may be interested in joining. Each illustrated group listing 102 includes the number of group members 104, the number of group friends 106, several photos 108 of group members, the group name 110, and the beginning of a group description 112. By selecting or touching one of the group listings 102, the user is taken to that group's individual group page. Below the listing of recommended groups, the illustrated recommended groups page displays the same row of links or inputs (“Home”, “Schedule”, “Connect”, Messages, and “More”) 88 as discussed above. It is noted that the recommended groups page 100 can alternatively have any other suitable form.

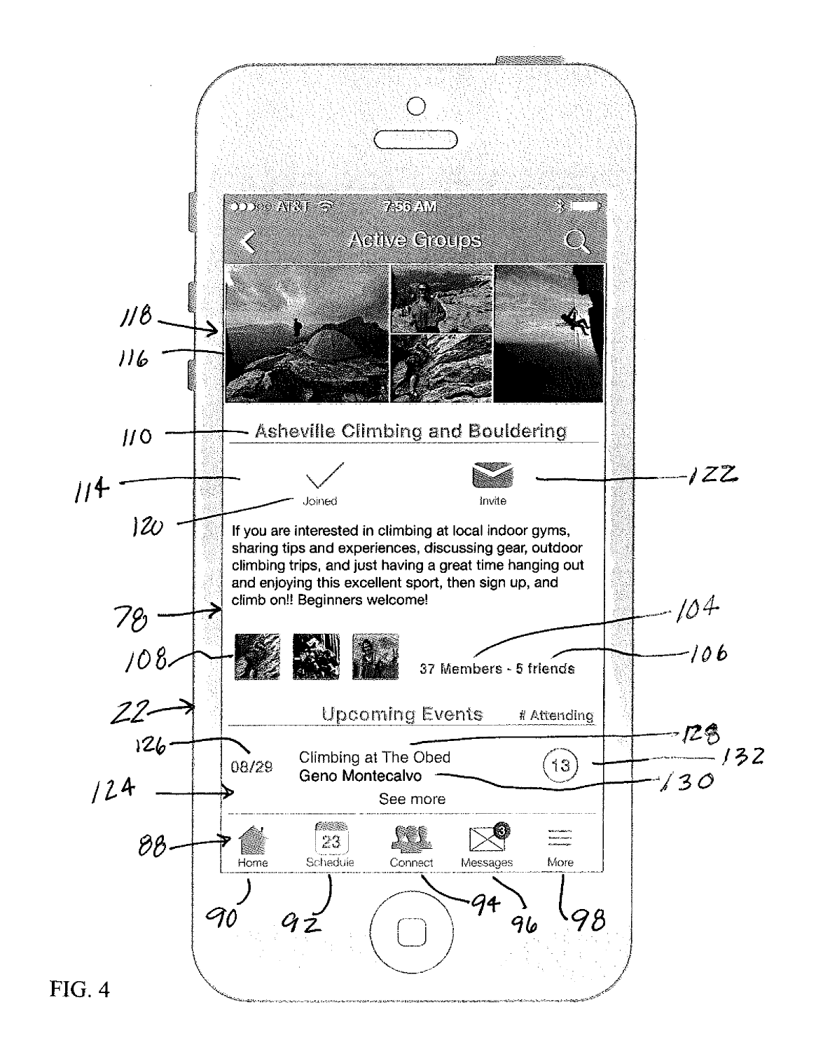

FIG. 4 illustrates an exemplary individual group page 114 displaying information regarding one of the groups (“Ashville Climbing and Bouldering”) by touching or selecting the group listing 102 on the recommended group page 100 (see FIG. 3). The illustrated individual group page 114 displays the group name (“Ashville Climbing and Bouldering”) 110 near the top of the page 114 with a plurality of member selected photographs 116 located above the group name 114. The illustrated plurality of member selected photographs 116 is displayed in the form of a group photograph collage 118. The illustrated photograph collage 118 includes four of the photographs 116: a first relatively large photograph located on the left side of the touch screen 78; second and third relatively small photographs located one above the other to the right of the first photograph; and a fourth photograph sized smaller than the first photograph and larger than the second and third photographs and located on the right side of the touch screen 78. It is noted, however, that the photographs 116 can be automatically displayed in any one of a plurality of predefined patterns depending on the characteristics of the particular photographs 116 displayed. Below the collage of photographs 118 of the illustrated individual group page 118 are links or inputs (“Joined” and “invite”) 120, 122 on the touch screen 78 that when selected or touched by the user 22 will take the user to a join group page and an invite to group page, respectively. Also displayed on the illustrated individual group page 118 are the full group description 112 and a listing of upcoming group activities or events 124 that when selected or touched will take the user to an individual activity page. Each illustrated listing includes the activity date 126, the activity name 128, the activity recommending member 130, the number of attending members 132, and a link to an activity page 134. Below the listing of upcoming events or activities 124, the illustrated individual group page 114 displays the same row of links or inputs (“Home”, “Schedule”, “Connect”, Messages, and “More”) 88 as discussed above. It is noted that the individual group page 114 can alternatively have any other suitable form.

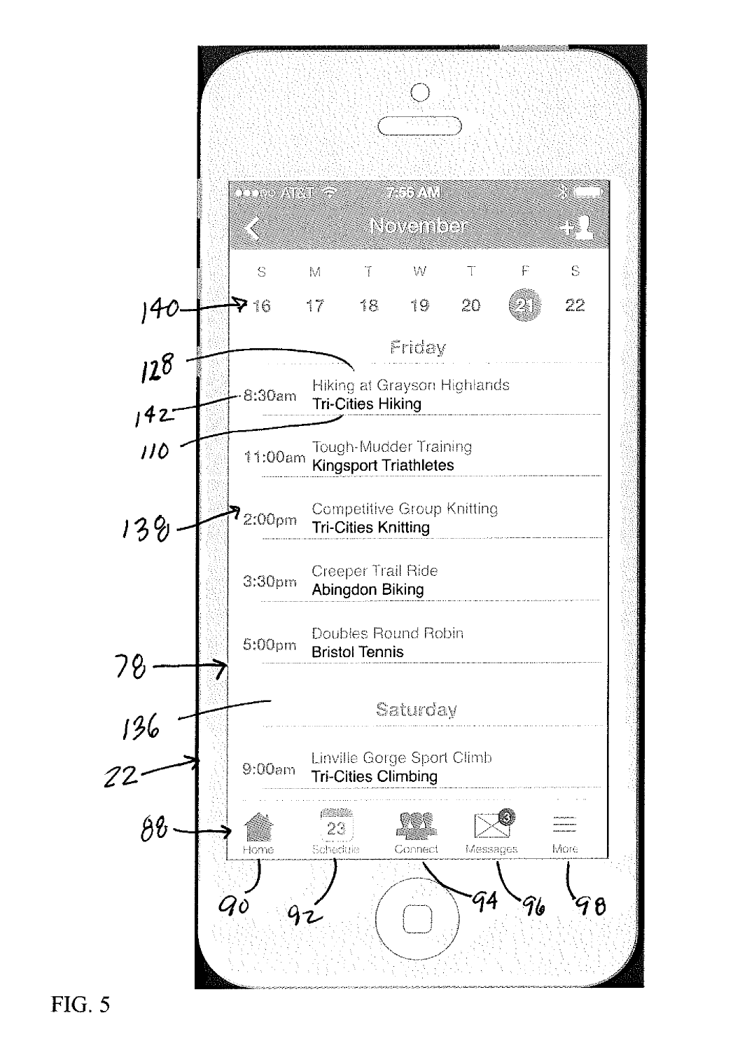

FIG. 5 illustrates an exemplary schedule of activities page 136 displaying a listing of activities 138 by date which can be displayed by touching or selecting the schedule link 92. The user 22 can select a calendar day from the plurality of days 140 displayed along the top of the page 136 and any posted activities or events for that particular day will be displayed below. Each illustrated activity listing has the activity start time 142, the activity name 128, and the group name 110 of the group scheduling the activity. Below the listing of upcoming activities 138 , the illustrated schedule of activities page 136 displays the same row of links or inputs (“Home”, “Schedule”, “Connect”, Messages, and “More”) 88 as discussed above. It is noted that the schedule of activities page 136 can alternatively have any other suitable form.

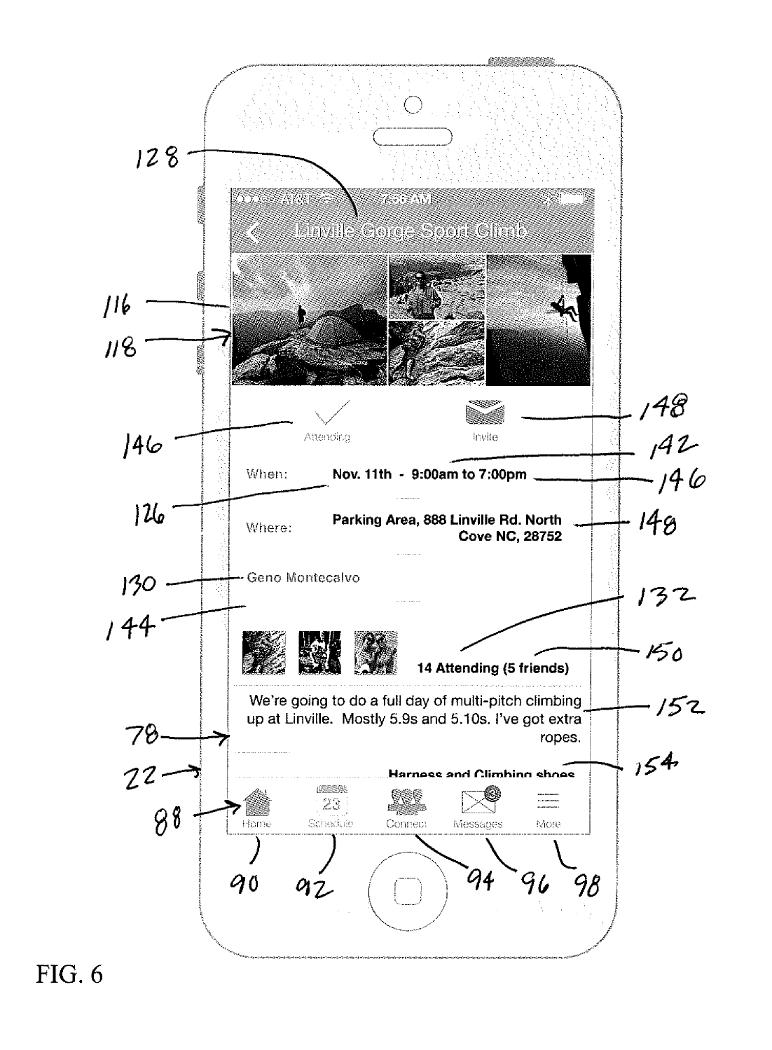

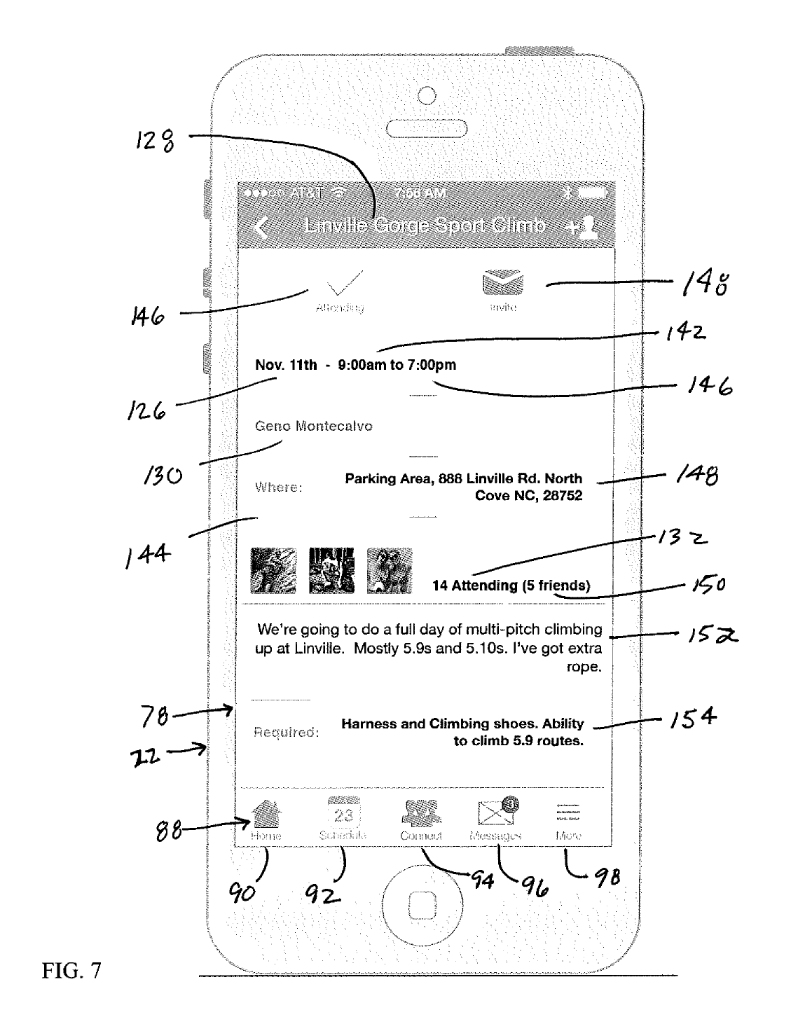

FIGS. 6 and 7 illustrate an exemplary individual posted activity page 144 displaying the activity name or title 128 of the posted upcoming activity (“Linville Gorge Sport Climb”). Below the activity name 128, the plurality of member selected photographs 116 is displayed. Below the collage of photographs 118 of the illustrated individual posted activity page 144, are links or inputs (“Attending” and “invite”) 146, 148 on the touch screen 78 that when selected or touched by the user will take the user to a join activity page and an invite to activity page, respectively. Also displayed on the illustrated individual posted activity page 144 are the activity date 126, activity start and finish times 142, 146, the name of the group member 130 that proposed the activity, the meeting location 148 for the activity, the total number of people attending 132 along with the number of friends attending 150 included in the total 132 and a several photographs 108 of the group members attending, a description 152 of the group activity, and any requirements 154 for the group activity such as, for example, required equipment, required skill level, and/or the like. At the bottom, the illustrated schedule of activity page 144 displays the same row of links or inputs (“Home”, “Schedule”, “Connect”, Messages, and “More”) 88 as discussed above. it is noted that the activity page 144 can alternatively have any other suitable form.

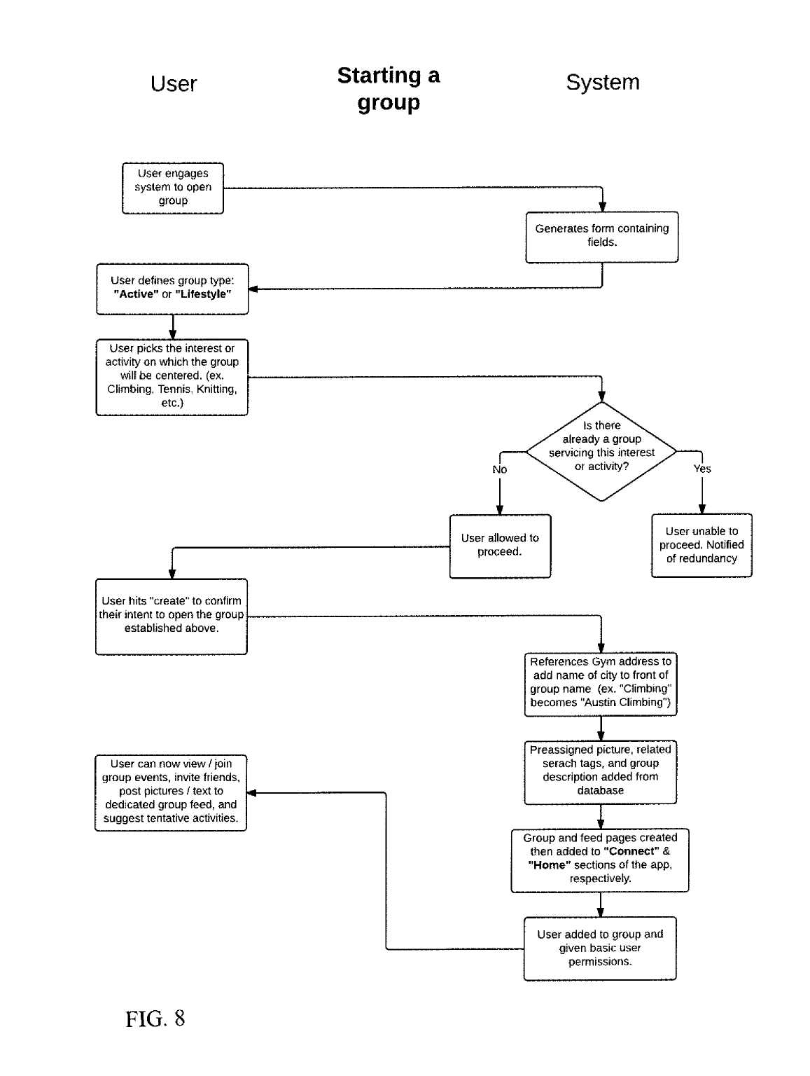

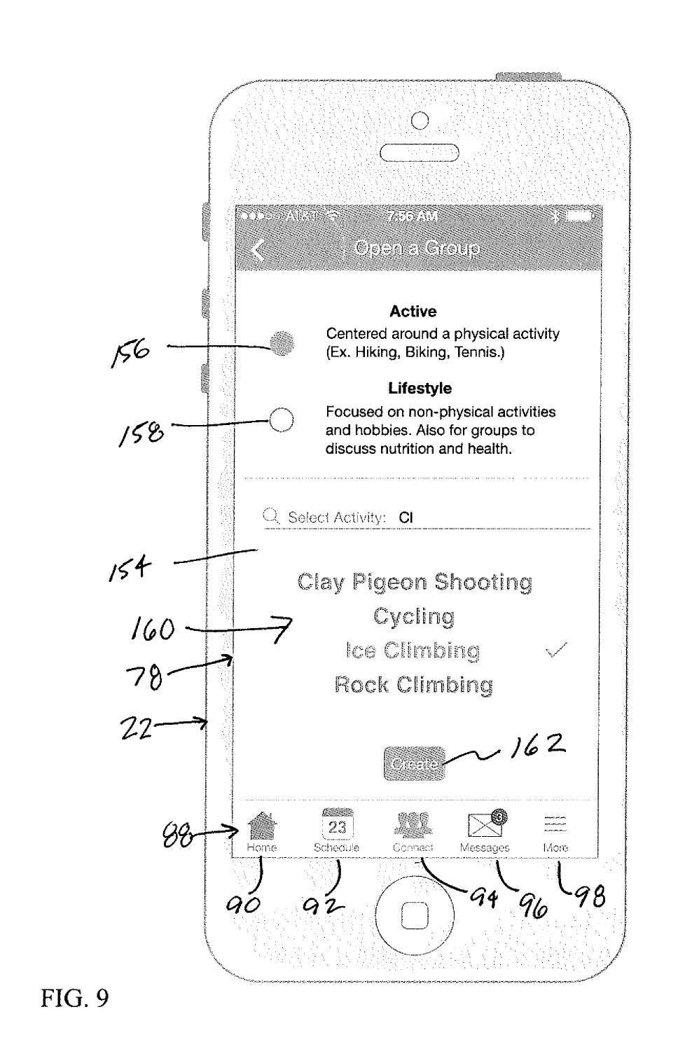

FIG. 8 illustrates a flow diagram showing how a user can start a new group according to the present invention. First the user 22 indicates that they want to open a new group by selecting the suggest activity link 84 and the software displays a form 154 containing fields for entering information regarding the new group. The user defines the group type as either “Active” (centered around a physical activity) 156 or “Lifestyle” (focused on non-physical activities and hobbies including nutrition and health) 158 and then selects the interest or activity on which new group will be centered from a predetermined list 160 automatically provided to the user such as, for example, clay pigeon shooting, cycling, ice climbing, rock climbing etc. (see FIG. 9). The software then automatically determines whether there is already a group servicing the indicated interest or activity. If there is an existing group, the user 22 is notified of the redundancy and is unable to continue creating the new group. If there is not an existing group, the user 22 is notified that they are allowed to proceed with creating a new group. The user must select a “create” link or input 162 in order to confirm their desire to continue to open the new group (see FIG. 9). It is noted that the new group selection page 154 can alternatively have any other suitable form. The software then automatically references the sponsor address to add the name of the sponsor's city in the beginning of the group type to form the group name 110. For example, “Climbing” becomes “Austin Climbing”. Thus, the group name 110 is automatically generated from the name selected from the group type list 160 and the sponsor's city resulting in uniform group names 110. The group names 110 are not determined by the requesting user. The software then automatically provides a pre-assigned photo, related search tags, and group description to the database of groups, The individual group and group feed pages are then automatically created and added to the “Connect” and “home” sections of the application respectively. The requesting user is then added to the group and given basic user permissions. The requesting user can then view/join group events, invite friends, post photos/text to the dedicated group feed, and propose tentative group activities.

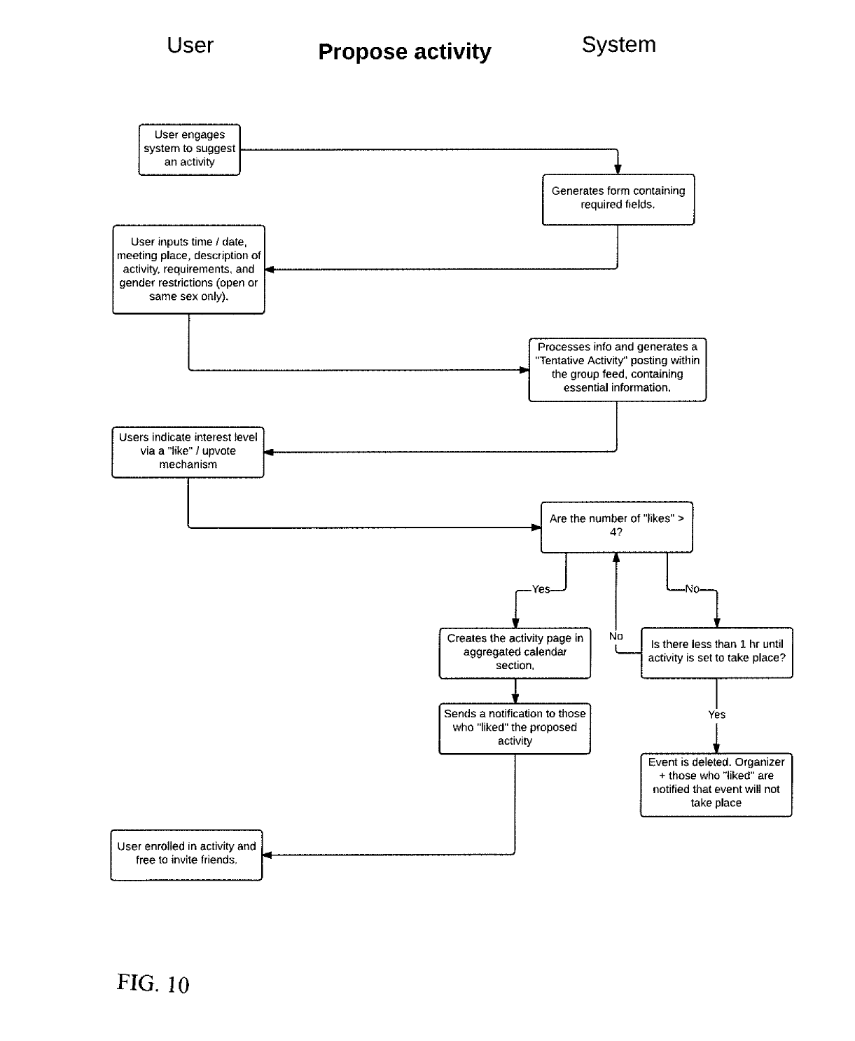

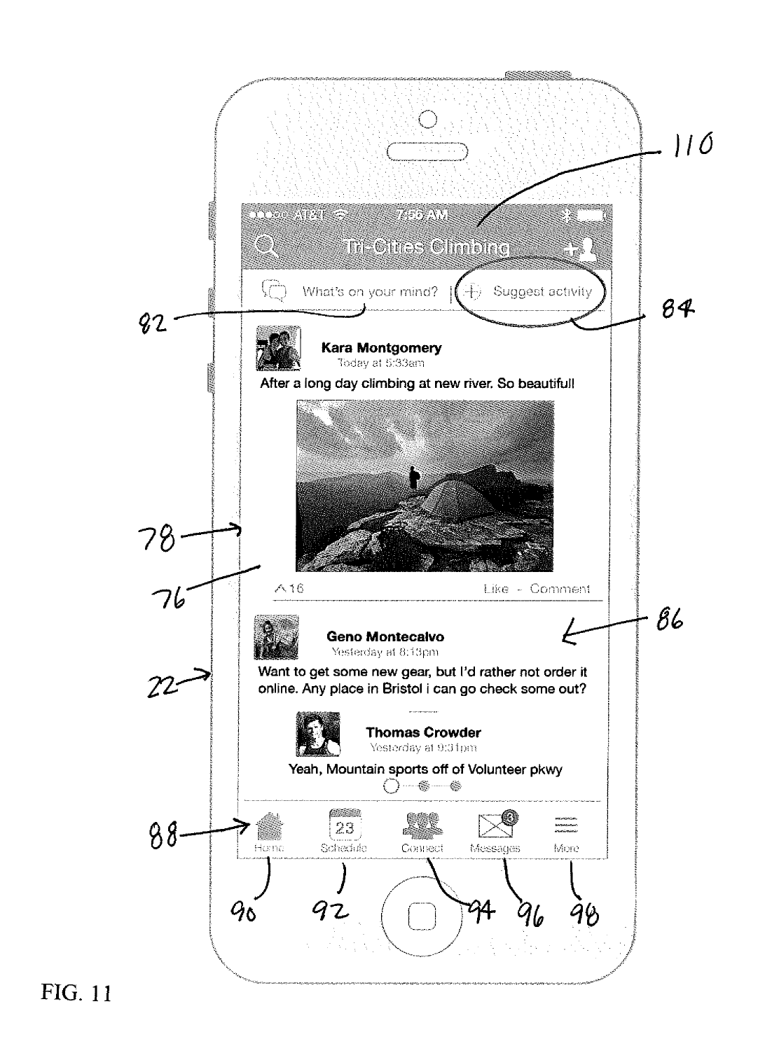

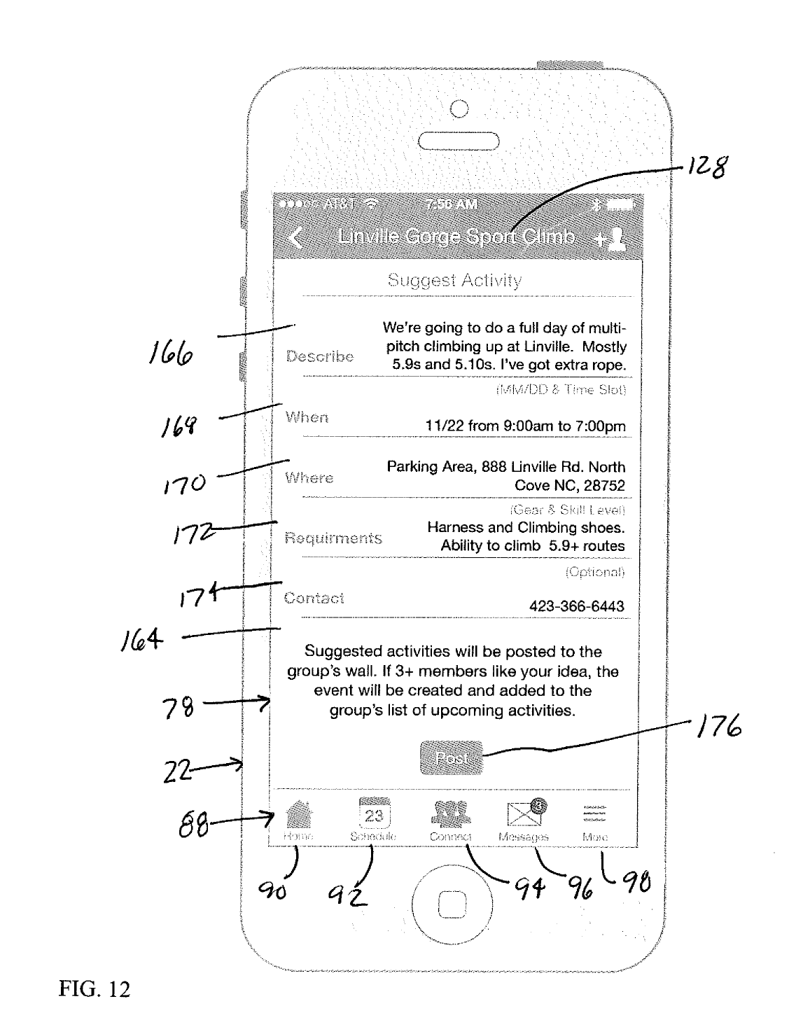

FIG. 10 illustrates a flow diagram showing how a user 22 can propose a new group activity or event according to the present invention. First the user indicates that they want to propose a new group activity by selecting or touching the “suggest activity” link or input 84 on the group feed or home page 76 (see FIG. 11) and the software displays a form 164 containing fields for entering information regarding the proposed group activity (see FIG. 12). The illustrated fields include a description of the proposed activity 166, the date and start and finish times for the proposed group activity 168, the meeting location for the proposed group activity 170, gear and skill level requirements for the proposed group activity 172, contact information (that is optional) of the user proposing the new group activity 174. The user 22 then must select or touch a link or input (“Post”) 176 with posting the proposed group activity. It is noted that the suggested activity input page 164 can alternatively have any other suitable form.

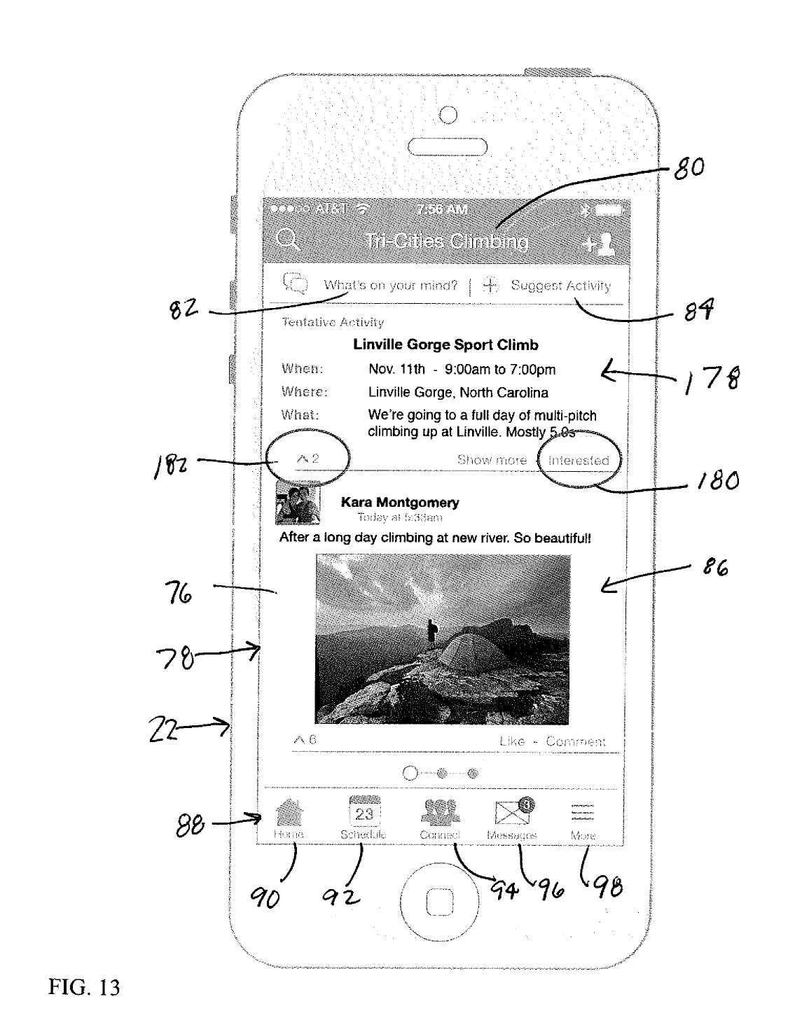

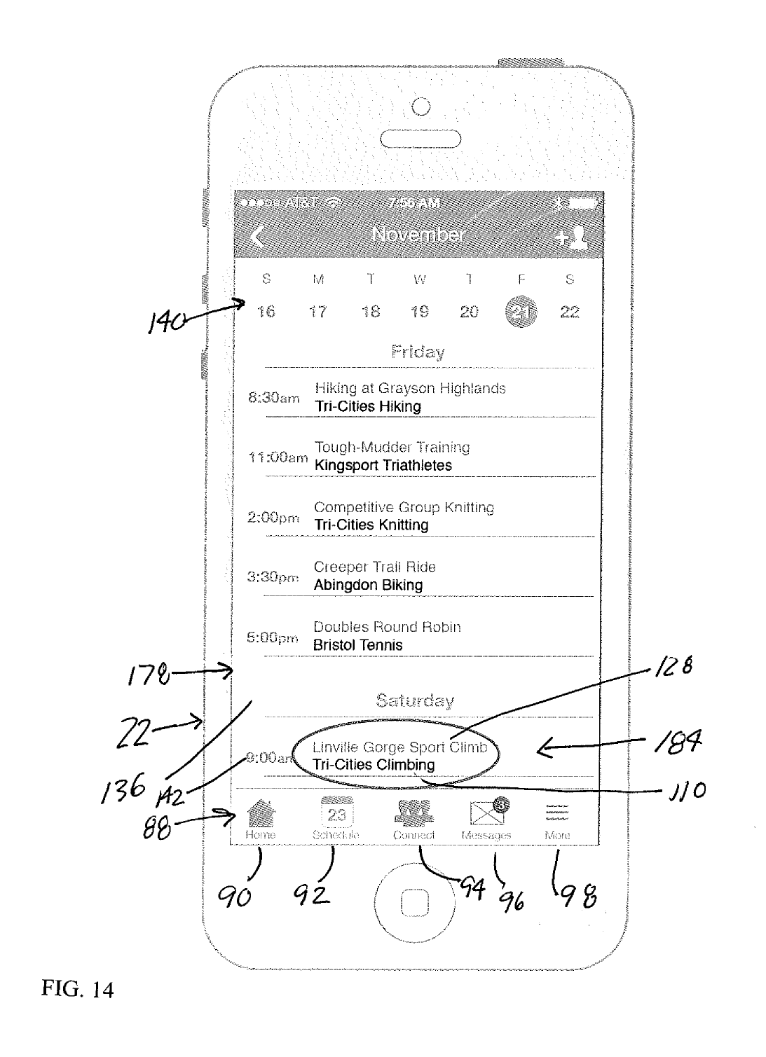

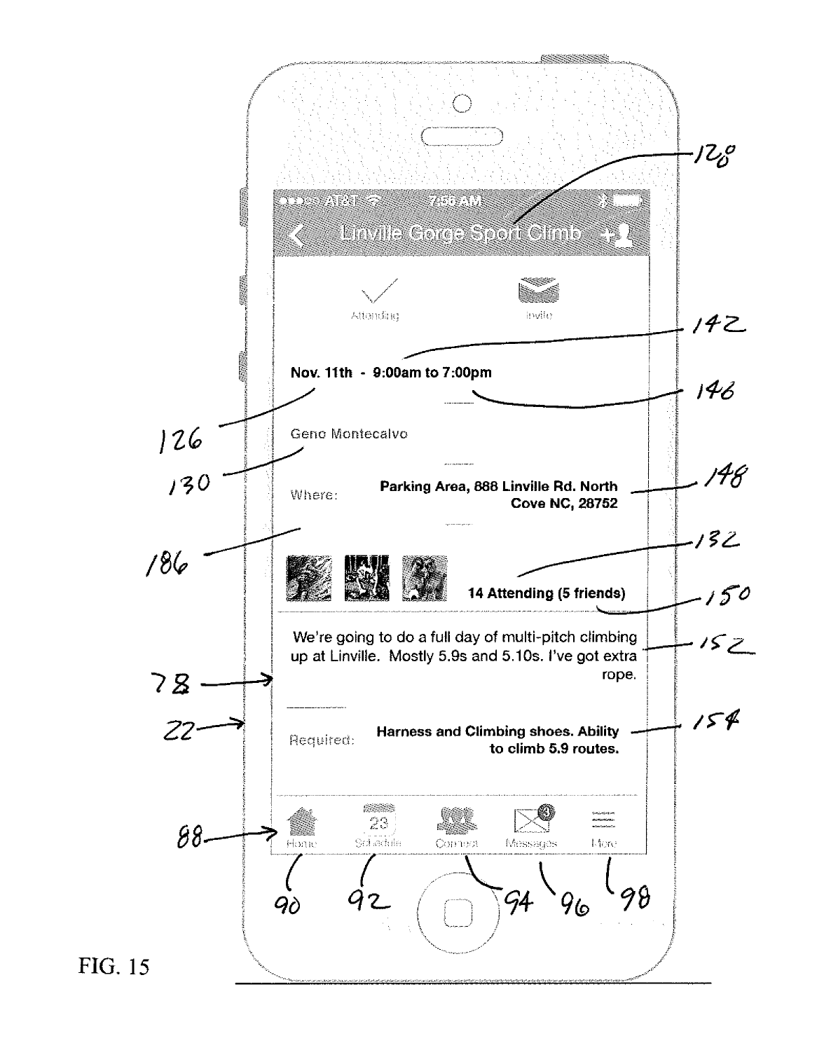

As best shown in FIG. 13, the software then automatically generates a “Tentative Activity” posting 178 which is displayed on the group feed page 76 that displays at least some of the information about the proposed group activity and also automatically generates a listing 184 on the calendar page (best shown on FIG. 14). Additional information regarding the proposed activity can be viewed on a tentative individual activity page 186 (shown in FIG. 15) which the user can go to by selecting the “show more” link. Also displayed is a link or input (“Interested”) 180 which when selected by a user 22 provides a positive level of interest in joining the tentative activity. The illustrated embodiment also displays a number 182 indicating the quantity of positive responses already received such as, for example, the number “2” shown in FIG. 13. It is noted that users 22 cannot join the tentative activity while it is posted as a tentative activity. As users 22 view the tentative activity posting and indicate any positive level of interest in the proposed group activity, the software automatically compares the current number 180 of positive level of interests received with a predetermined number of positive level of interest that automatically triggers the software to automatically create an individual activity page 144 for the new activity that can be reached via the aggregated calendar page 136. The predetermined number of positive level of interest can be any suitable number such as, for example, 4. When the individual activity page 144 is created for the new group activity, the software automatically sends a notification of the generation of the activity page for the proposed in-person activity to the users 22 who sent a positive interest level for the proposed or tentative in-person activity. These users 22, and any other users 22, can then enroll or join the newly posted group activity. It is noted that the tentative activity posting 178 can alternatively have any other suitable form.

However, the software automatically deletes the tentative activity posting 178 (along with the calendar listing 184 and the tentative individual activity page 186) for the proposed in-person activity at a predetermined time if the predetermined number of the positive interest level has not been received from the users 22. The predetermined time can be any suitable time such as, for example, one hour or one day etc. prior to the propose start time for the proposed or tentative group activity. If the tentative activity posting 178 is deleted, the software automatically sends an electronic notification of the deletion of the tentative activity posting 178 to users 22 who sent a positive interest level for the proposed in-person activity and that the proposed activity will not take place.

It should be appreciated from the above description that the scheduling of the new group activities is a democratic process for the group members 22. That is, a predetermined level of interest of the group members 22 determines which if any of the proposed group events are scheduled. Administrators do not make any determination as to scheduling or not scheduling group events or activities. The term “democratic is used herein to mean “control of the organization or group is by the majority and/or predetermined number of its members”.

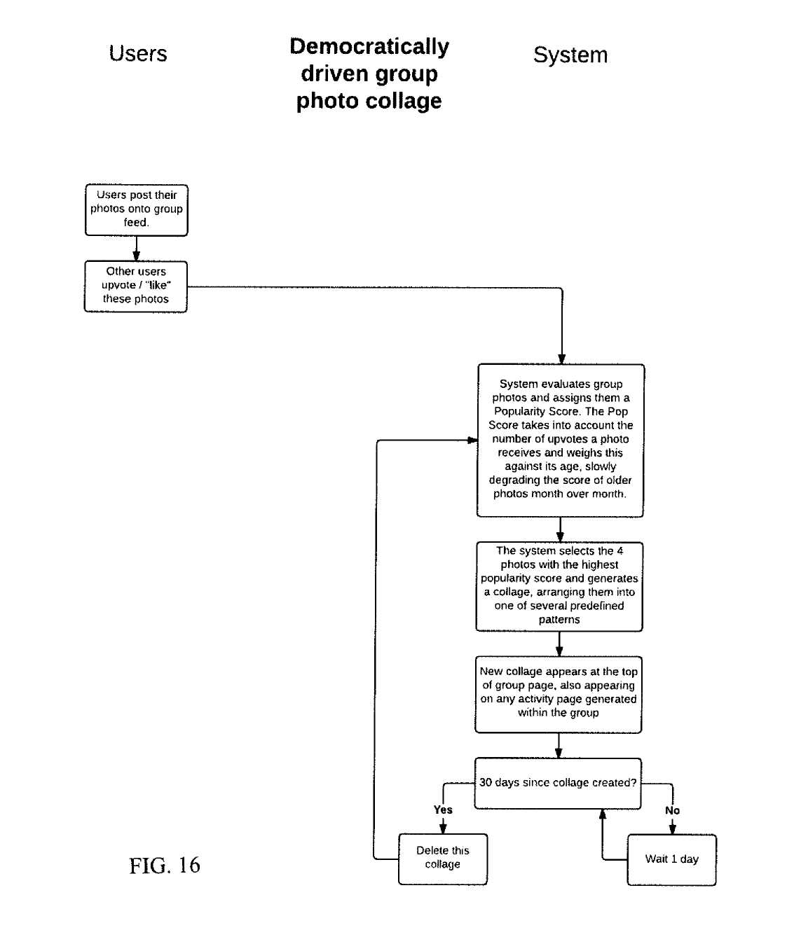

FIG. 16 illustrates a flow diagram showing a method for group members selecting photographs to be displayed in the group photograph collage 188 with a democratic process. Members of a group can post photographs 188 onto the group feed (see FIG. 2). In the illustrated embodiment, other group members can indicate a positive response to any posted photograph and can post comments to the post. The illustrated means for indicating a positive response to a posted photograph 188 is in the form of a “Like” button 190 but any other suitable means can alternatively be utilized. The illustrated embodiment also displays a number 192 indicating the quantity of positive responses received such as, for example, the number “16” shown in FIG. 2. The software automatically evaluates all posted photographs 188 and assigns each posted photograph 188 with a Popularity Score. The Popularity Score takes into account the quantity of positive responses received from group members for the photograph 188 and the age of the photograph 188 (that is, the period of time that the photograph 188 has been posted). In the illustrated embodiment, the Popularity Score is slowly downgraded or decreased overtime so that it is decreased a predetermined amount at a predetermined period of time. For example, the Popularity Score can be decreased an amount of 10% for every additional 30 days it has been posted. The software automatically selects a predetermined number of the posted photographs 188 with the highest Popularity Scores and populates the group photograph collage 118 with the highest scoring photographs 116. The illustrated predetermine number is four but any other suitable quantity of photographs can alternatively be utilized. The highest scoring photographs 116 are arranged in one of a plurality of predefined patterns depending on the characteristics of the particular photographs 116 to be displayed. The group photograph collagen 118 is displayed on the top of the group page 114 (see FIG. 4) and the top of each individual activity page 144 for the group (see FIG. 6). The illustrated software reevaluates the Popularity Scores of the posted photographs 188 every 30 days and updates the group photograph collage 188 if needed, but the Popularity Scores can alternatively be reevaluated in real time or any other suitable predetermined period of time.

Any of the features or attributes of the above described embodiments and variations can be used in combination with any of the other features and attributes of the above described embodiments and variations as desired.

It is apparent from the above detailed description of preferred embodiments of the present invention, that the above-disclosed systems, methods, and software are designed to electronically facilitate group activities or events while providing positive user experience and/or reducing administrative costs for the sponsor.

It is also apparent from the above detailed description of preferred embodiments of the present invention, that the above-disclosed systems, methods, and software can be modified to include additional or alternative features.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled

What is claimed is:

1. A computer implemented method for facilitating in-person activities, said method comprising the steps of, in combination:
electronically receiving information from a user for a proposed in-person activity;
electronically generating a tentative activity posting for the proposed in-person activity within a group feed;
wherein the tentative activity posting for the proposed in-person activity does not permit users to electronically enroll in the proposed in-person activity;
electronically receiving positive interest level for the tentative activity posting from users of the group feed;
electronically generating an activity page for the proposed in-person activity when a predetermined number of the positive interest level is received from the users;
wherein the activity page for the proposed in-person activity permits users to electronically enroll in the proposed in-person activity; and
electronically deleting the tentative activity posting for the proposed in-person activity at a predetermined time if the predetermined number of the positive interest level has not been received from the users.

2. The computer implemented method of claim 1, wherein the information includes time, date, meeting place, and description of activity.

3. The computer implemented method of claim 2, wherein the information includes activity requirements and gender restrictions.

4. The computer implemented method of claim 1, wherein the predetermined number is 4.

5. The computer implemented method of claim 1, further comprising the step of electronically sending a notification of generation of the activity page for the proposed in-person activity to users who sent a positive interest level for the proposed in-person activity.

6. The computer implemented method of claim 1, wherein the predetermined time is one hour before the activity time.

7. The computer implemented method of claim I , further comprising the step of electronically sending a notification of deletion of the activity page for the proposed in-person activity to users who sent a positive interest level for the proposed in-person activity.

8. A system for facilitating in-person activities, said system comprising, in combination:
at least one central computer having memory, a processor in communication with the memory, and a network interface in communication with the processor for communicating with mobile electronic devices; and
wherein the memory comprising computer-executable instructions executable by the processor to perform the following steps:
electronically receiving information from a user for a proposed in-person activity;
electronically generating a tentative activity posting for the proposed in-person activity within a group feed;
wherein the tentative activity posting for the proposed in-person activity does not permit users to electronically enroll in the proposed in-person activity;
electronically receiving positive interest level for the tentative activity posting from users of the group feed;
electronically generating an activity page for the proposed in-person activity when a predetermined number of the positive interest level is received from the users;
wherein the activity page for the proposed in-person activity permits users to electronically enroll in the proposed in-person activity; and
electronically deleting the tentative activity posting for the proposed in-person activity at a predetermined time if the predetermined number of the positive interest level has not been received from the users.

9. The system of claim 8, wherein the information includes time, date, meeting place, and description of activity.

10. The system of claim 9, wherein the information includes activity requirements and gender restrictions.

11. The system of claim 8, wherein the predetermined number is 4.

12. The system of claim 8, further comprising the step of electronically sending a notification of generation of the activity page for the proposed in-person activity to users who sent a positive interest level for the proposed in-person activity.

13. The system of claim 8, wherein the predetermined time is one hour before the activity time.

14. The system of claim 8, further comprising the step of electronically sending a notification of deletion of the activity page for the proposed in-person activity to users who sent a positive interest level for the proposed in-person activity.

15. One or more computer-readable media storing an application for facilitating in-person activities comprising computer-executable instructions that responsive to execution cause operations to be performed comprising, in combination:
electronically receiving information from a user for a proposed in-person activity;
electronically generating a tentative activity posting for the proposed in-person activity within a group feed;
wherein the tentative activity posting for the proposed in-person activity does not permit users to electronically enroll in the proposed in-person activity;
electronically receiving positive interest level for the tentative activity posting from users of the group feed;
electronically generating an activity page for the proposed in-person activity when a predetermined number of the positive interest level is received from the users;
wherein the activity page for the proposed in-person activity permits users to electronically enroll in the proposed in-person activity; and
electronically deleting the tentative activity posting for the proposed in-person activity at a predetermined time if the predetermined number of the positive interest level has not been received from the users.

16. The one or more computer-readable media of claim 15, wherein the information includes time, date, meeting place, and description of activity.

17. The one or more computer-readable media of claim 16, wherein the information includes activity requirements and gender restrictions.

18. The one or more computer-readable media of claim 15, wherein the predetermined number is 4.

19. The one or more computer-readable media of claim 15, further comprising the step of electronically sending a notification of generation of the activity page for the proposed in-person activity to users who sent a positive interest level for the proposed in-person activity.

20. The one or more computer-readable media of claim 15, wherein the predetermined time is one hour before the activity time.
